(19) United States
(12) Patent Application Publication
(10) Pub. No.: US 2007/0019404 A1
(43) Pub. Date: Jan. 25, 2007

(54) Hanging lighted decorative device

(75) Inventor: Chi Gon Chen, Guang Zhou (CN)

Correspondence Address: Alan R. Thiele;Strasburger & Price, LLP, Suite 4400, 901 Main St., Dallas, TX, 75202, US

(73) Assignee: International Development Corporation

(21) Appl. No.: 11/184,635

(22) Filed: Jul. 19, 2005

(51) Int. Cl. F21L 13/00

(52) U.S. Cl. 362/192

(57) ABSTRACT

A hanging lighted decorative device includes a solar-powered lighting assembly. Hanging from the solar-powered lighting assembly are one or more wind chimes. In the midst of the wind chimes is an optional impact device.

### FIELD

The present invention pertains to a decorative device; more particularly the present invention pertains to a lighted decorative device hung from an overhead support.

### BACKGROUND

In many outdoor areas, on patios attached to residences or in rooms just inside outdoor areas, those who occupy these outdoor areas, patios, or rooms just inside outdoor areas decorate them with hanging devices. Some of these hanging devices include one or more chimes which emit pleasing sounds when moved by breezes or the force of blowing wind. Unfortunately, when darkness falls at the end of the day, many elect to leave outdoor areas, patios, or rooms just inside outdoor areas because of the lack of light.

In recent years, many manufacturers of lighting products, particularly lighting products used outdoors, have incorporated solar panels with lighting products to provide electrical power without having to run wires to carry electrical energy to the lighting products. While such solar panels have found uses in such lighting products as pathway lighting, garden lights, or illuminated address signs, such solar panels have not been incorporated into many other objects frequently found in outdoor areas, patios, or rooms close to outdoor areas.

Accordingly, a need remains in the art to incorporate a solar-powered lighting function into objects frequently found in outdoor areas, patios, or rooms close to outdoor areas.

### SUMMARY

The device and method of the present invention incorporates solar-powered lighting into hanging decorations typically found in outdoor areas, patios, or in rooms adjacent to outdoor areas, more particularly a wind chime.

The disclosed hanging lighted decorative device of the present invention includes a solar-powered lighting assembly together with hollow tubes which produce sounds when either moved against each other or struck by an impact device because of the force provided by moving air. The hollow tubes are suspended or hung beneath the solar-powered lighting assembly. The solar-powered lighting assembly is hung from an overhead support.

Users of the disclosed hanging lighted decorative device will be able to enjoy the sounds of a wind chime while, at the same time, having the benefit of light emitted by the solar-powered lighting assembly.

### BRIEF DESCRIPTION OF THE DRAWING FIGURES

A better understanding of the hanging lighted decorative device of the present invention may be had by reference to the drawing figures, wherein:

FIG. 1 is a perspective view of the hanging lighted decorative device of the present invention.

FIG. 2 is a front elevational view.

FIG. 3 is an exploded view illustrating the componentry of the present invention.

### DESCRIPTION OF THE EMBODIMENTS

The hanging lighted decorative device 10 of the present invention includes a lighting assembly 20 which is constructed to transform light energy into electrical energy, store the electrical energy in a storage device, such as a battery 22, and then emit light from a light source 24 such as an LED. The hanging lighted decorative device 10 is hung or suspended from an overhead support.

Suspended underneath or hanging from the lighting assembly 20 is a collection 40 of hollow tubes 42 having different lengths. Each hollow tube 42 emits a different sound when either struck by a suspended impact device 44 or struck by another tube 42 in response to the force of moving air. If desired, the suspended impact device 44 may be weighted 46 to restrict its movement.

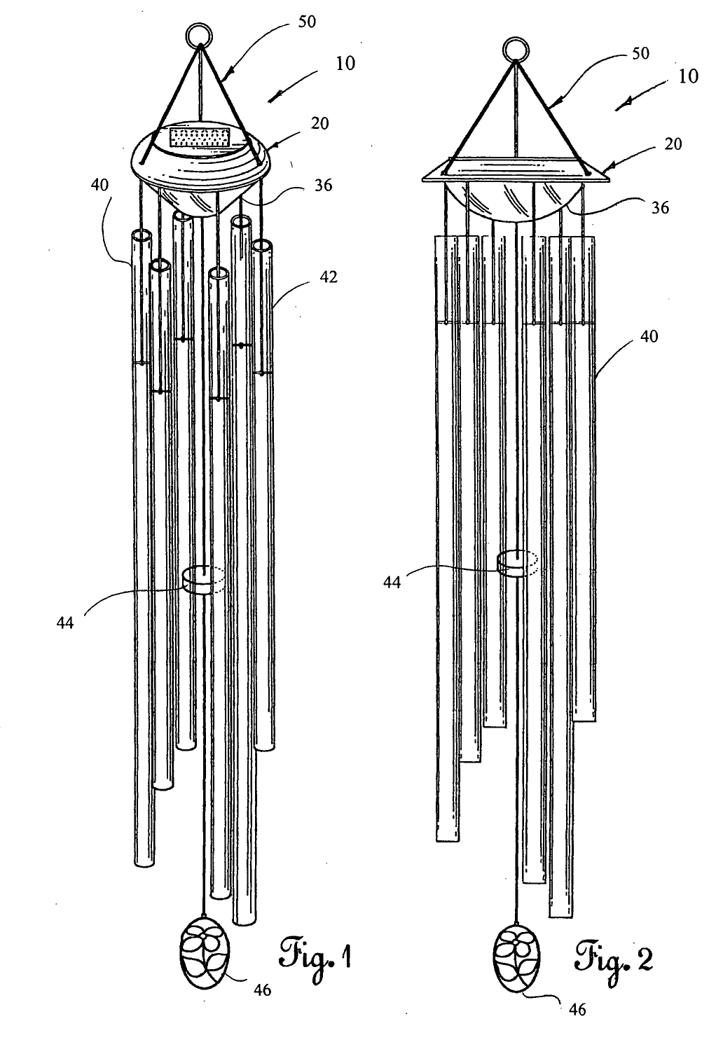

As best seen in FIG. 1, the hanging decorative device 10 of the present invention includes a hanger assembly 50 which suspends the hanging decorative device 10 of the present invention from an overhead support. Just beneath the hanger 50 is the lighting assembly 20. In the preferred embodiment, the lighting assembly 20 is solar-powered. Specifically, the lighting assembly 20 converts light rays into electrical power, stores the electrical power in a battery 26, and uses the electrical power to illuminate a light source 24. The light source 24 may either be an incandescent light or an LED.

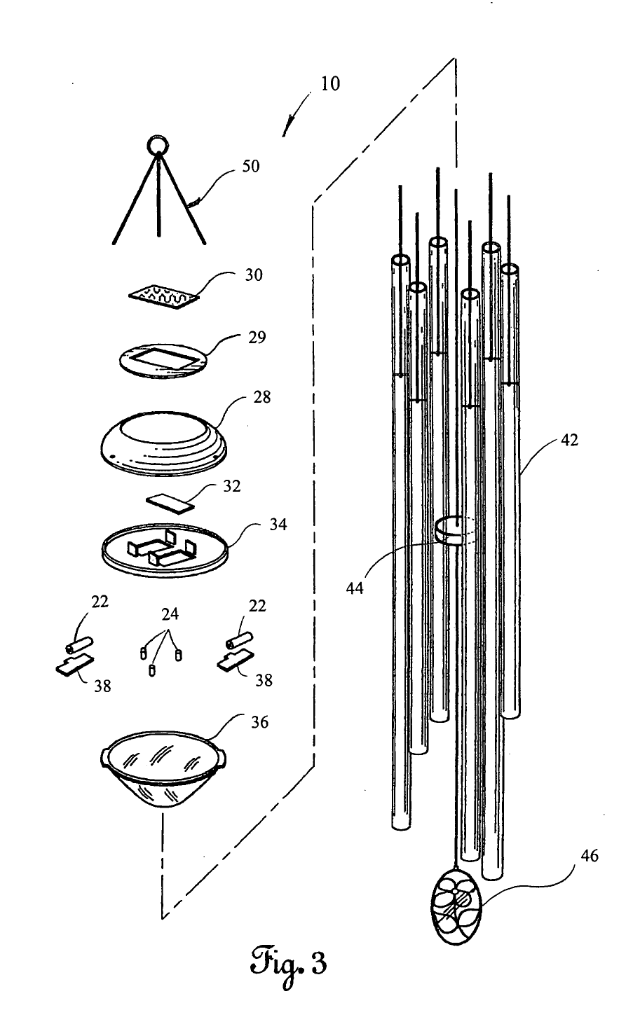

The componentry included in such solar-powered lighting assemblies shown in FIG. 3 is well known to those of ordinary skill in the art. Specifically, the suspended lighting assembly 20 includes a top cover 28 which provides mounting 29 for a solar panel 30. Light energy converted to electrical energy by solar panel 30 passes through circuit board 32 to be stored in one or more batteries 22. Electrical energy from the batteries 22 is used to illuminate one or more light sources 24. A bottom cover 34 is connected to the top cover 28 to provide a chamber for protecting the electrical components. Beneath the bottom cover 34 is mounted a translucent lens 36. Removal of the translucent lens 36 from the bottom cover 34 provides access to the batteries 22 by allowing further access to movable cover panels or doors 38.

In the illustrated embodiment, the lighting assembly 20 is substantially circular and includes an upper or cover portion 28 and a lower translucent lens portion 36. The electrical componentry, to include the solar panel 30, the circuitry 32, the electrical storage battery 26, and the light source 24, are all contained within the cover portion 28. In the preferred embodiment, the circumference of the substantially circular translucent lens portion 36 is slightly smaller than the cover portion 28. Those of ordinary skill in the art will understand that a translucent lens portion 36 is helpful in outdoor areas to protect the light source; however, in protected areas, the translucent lens portion 36 may not be needed.

Suspended from the lighting assembly 20 are one or more chimes selected for their ability to emit sound when struck by another chime or by an impact member. In the preferred embodiment, a plurality of tubes of different lengths is used; however, any objects which emit a pleasing sound when moved by air or typically used in wind chimes may be suspended from the lighting assembly 20 without departing from the scope of the present invention. The objects selected are preferably chosen for their ability to emit harmonic tones when moved by the action of the wind.

Those of ordinary skill in the art will understand that numerous other embodiments of the disclosed invention have been enabled by the foregoing disclosure. Such numerous other embodiments shall be included within the scope and meaning of the appended claims.

What is claimed is:

1. A hanging decorative device comprising:
a lamp assembly powered by electrical energy obtained from light energy; and
at least one suspended wind chime hanging downwardly from said lamp assembly.

2. The hanging decorative device as defined in claim 1 further including an impact piece suspended to hang from said lamp assembly and positioned to impact said at-least one wind chime.

3. The hanging decorative device as defined in claim 1 wherein said lamp assembly includes a cover portion and a translucent lens portion.

4. The hanging decorative device as defined in claim 3 further including a panel for transforming light energy into electrical energy in said cover portion.

5. The hanging decorative device as defined in claim 4 wherein said panel is a solar panel.

6. The hanging decorative device as defined in claim 2 further including a weight suspended from said impact piece.

7. The hanging decorative device as defined in claim 3 wherein said lamp assembly includes an incandescent lamp.

8. The hanging decorative device as defined in claim 3 wherein said lamp assembly includes an LED.

9. The hanging decorative device as defined in claim 3 wherein said lamp assembly includes a battery for storing electrical energy.

10. The hanging decorative device as defined in claim 2 including a plurality of wind chimes whose sizes are selected for sound produced when impacted by said impact piece.

11. An outdoor hanging decorative device comprising:
a hanger assembly;
a solar-powered lamp assembly constructed and arranged for suspension from said hanger assembly;
a plurality of hollow tubes hanging from said solar-powered lamp assembly.

12. The outdoor hanging decorative device further including an impact piece constructed and arranged to be suspended from said solar-powered lamp assembly and to impact said hollow tubes upon movement of said hollow tubes.

13. The outdoor hanging decorative device further including a weight suspended from said impact piece.

14. The outdoor hanging device as defined in claim 12 wherein said hollow tubes are selected to emit harmonic tones when impacted by said impact piece.

15. The outdoor hanging device as defined in claim 11 wherein said solar-powered lamp assembly will continue to emit light using electricity stored within a battery.

16. A method of constructing a hanging decorative device, said method comprising the steps of:
hanging a solar-powered light assembly from an overhead support;
hanging at least one tone-emitting chime from said solar-powered light assembly.

17. The method as defined in claim 16 further including hanging a chime-impacting device from said solar-powered light assembly.

18. The method as defined in claim 17 further including hanging a weight from said chime-impacting device.
